(19) United States
(12) Patent Application Publication
(10) Pub. No.: US 2024/0180137 A1
(43) Pub. Date: Jun. 6, 2024

(54) CARTRIDGE, ANTI-TERMITE DEVICE, AND ITS APPLICATION METHOD

(71) Applicants: Tsuyoshi YOSHIMURA; Izumi FUJIMOTO, Kyoto (JP); Johji OHDAKE, Tokyo (JP); Bayer CropScience KK, Tokyo (JP); Kyoto University, Kyoto (JP); Discovery Purchaser Corporation, Wilmington, DE (US)

(72) Inventors: Tsuyoshi YOSHIMURA, Kyoto (JP); Izumi FUJIMOTO, Kyoto (JP); Johji OHDAKE, Tokyo (JP)

(21) Appl. No.: 18/457,108

(22) Filed: Aug. 28, 2023

(30) Foreign Application Priority Data
Jul. 19, 2022 (JP) 2022-115037

(51) Int. Cl. A01M 1/20; A01M 1/02; A01N 37/22; A01N 43/40; A01N 43/54; A01N 43/80

(52) U.S. Cl. CPC A01M 1/2022; A01M 1/026; A01N 37/22; A01N 43/40; A01N 43/54; A01N 43/80

(57) ABSTRACT

[Problem]

To provide a termite control device that does not require frequent checking of the device and that reduces the cost burden associated with providing a service.

[Solution]

The termite control device according to the present invention comprises: a cartridge having a structure including a member composed of a material that is resistant to decay or corrosion in soil and that is resistant to feeding damage by termites, thereby reducing feeding damage by termites, the structure having a passage through which the termites can move, and the structure containing an unavoidable, slow-acting insecticide active ingredient; and a container that is able to accommodate the cartridge and that is composed of a resin, a metal, a ceramic, or a composite of these materials. The container has a lid that can be opened and closed on the top surface thereof, and that has a plurality of through-holes or slits in a side surface thereof through which termites can enter.

### TECHNICAL FIELD

The present invention relates to a cartridge, a termite control device, and a termite control method. More particularly, the present invention relates to a cartridge, termite control device, and a termite control method for inhibiting or eradicating the activity of termite populations.

### BACKGROUND ART

One method of the prior art for termite control is to spray an insecticide having insecticidal action against termites on the soil under a building floor or on a concrete foundation surface to prevent termites from entering the building for a certain number of years and to kill them when they do enter.

Another termite control method is to embed a termite attracting device in outdoor soil, and after confirming the capture of termites, replacing a substrate that termites can forage on (such as a cellulose substrate) with insecticide-impregnated poison bait to eradicate the colony through termite nutrient replacement (see, for example, Patent Document 1).

### PRIOR ART DOCUMENTS

### Patent Documents

[Patent Document 1] JP 3024651 B2

### SUMMARY OF THE INVENTION

### Problem to be Solved by the Invention

These termite control methods raise concerns about exposure of workers, occupants, and employees to chemicals due to the spraying of biologically active chemicals under floors and other indoor areas. The diversity of building structures in recent years has also made it impossible to perform chemical spraying in some cases.

Other termite control methods can alleviate problems associated with these termite control methods. However, frequent checks on the device (for example, to detect termite infestation or change poison bait) are required. Therefore, there are challenges in terms of widespread adoption, primarily because of the labor costs incurred, which impose the cost burden associated with providing a service.

### Means for Solving the Problem

As a result of extensive research, the present inventors discovered that by using a termite repellent device equipped with a cartridge containing a non-repellent, slow-acting insecticide active ingredient and a container capable of holding the cartridge, need for frequent equipment checks could be eliminated, reducing the cost burden associated with providing a service. The present invention is based on this discovery.

One aspect of the present invention is a cartridge having a structure including a member composed of a material that is resistant to decay or corrosion in soil and that is resistant to feeding damage by termites, thereby reducing feeding damage by termites, the structure having a passage through which the termites can move, and the structure containing an unavoidable, slow-acting insecticide active ingredient.

Another aspect of the present invention is a termite control device comprising: the cartridge described above; and a container that is able to accommodate the cartridge and that is composed of a resin, a metal, a ceramic, or a composite of these materials, wherein the container has a lid that can be opened and closed on the top surface thereof, and that has a plurality of through-holes or slits in a side surface thereof through which termites can enter.

Still another aspect of the present invention is a termite control method for protecting a building from termite damage using the termite control device described above, the method further comprising a step of burying the termite control device in soil surrounding the building so that at least some of the through-holes or slits in a side surface of the container through which termites can enter are in the soil.

### Effects of the Invention

The cartridge in one aspect of the present invention has a structure including a member composed of a material that is resistant to decay or corrosion in soil and that is resistant to feeding damage by termites, thereby reducing feeding damage by termites, and containing an unavoidable, slow-acting insecticide active ingredient. Because the structure includes a member composed of a material that is resistant to feeding damage by termites and reduces feeding damage by termites, loss due to termite feeding can be reduced. Because the insecticide active ingredient is unavoidable and slow-acting, termites moving through the cartridge are exposed to the insecticide active ingredient for a certain period of time but are not immediately killed, and the interior of the cartridge does not become quickly filled with dead termites. Because the structure contains an insecticide active ingredient, termite paths are less likely to be formed in a termite passage inside the cartridges, and preferably no termite paths are formed at all. As a result, the cartridge does not need to be replaced frequently and can be used until the expiration date of the insecticide active ingredient.

Another aspect of the present invention is a termite control device comprising the cartridge described above, and a container that is able to accommodate the cartridge, and that has a plurality of through-holes or slits in a side surface thereof through which termites can enter. As mentioned above, the cartridge does not need to be replaced frequently and can be used until the expiration date of the insecticide active ingredient. As a result, there is no need to check the device frequently, which reduces the cost burden associated with providing a service. Because the container has a lid that can be opened and closed on the top surface, the cartridge is easy to replace after the expiration date. In another aspect of the termite control device of the present invention, the bottom of the container has an opening. In this aspect of the termite control device of the present invention, if water or fine particles of soil enter the container due to rainfall, they readily flow out of the container. Therefore, this aspect of the termite control device of the present invention is suitable for outdoor use.

Another aspect of the present invention is a termite control method, in which the termite control device is buried in soil surrounding a building so that at least some of the through-holes or slits in a side surface of the container through which termites can enter are in the soil. Termites enter through a through-hole or slit in the container in the soil through random probing behavior and are exposed to the insecticide active ingredient for a period of time as they move through a passage in the cartridge. Because the insecticide active ingredient is unavoidable and slow-acting, termites that enter the cartridge are exposed to the insecticide active ingredient for a certain period of time but are not immediately killed, and they return to the colony to transmit the insecticide active ingredient to other termites. As a result, a certain percentage of the colony population is killed, and the termites, being social insects, are unable to maintain the colony. In this way, the activity of termites can be inhibited or eradicated. In another embodiment of the termite control method of the present invention, a plurality of termite control devices are buried in soil surrounding a building, and guide members are arranged to connect at least some of the plurality of termite control devices to each other. The guide members have a recessed portion in its longitudinal direction and are positioned so that the recessed portions are facing downward vertically. This aspect of the present invention takes advantage of the habit of termites of moving along objects and around corners, and termites that have risen from the ground between termite control devices can be encouraged to move along the recessed portions of the guide members to a termite control device. In this way, the activity of termites can be further inhibited or eradicated.

### BRIEF DESCRIPTION OF THE DRAWINGS

FIG. 1A is a schematic plan view of a cartridge.

FIG. 1B is a schematic view of an end surface of the cartridge cut at the position indicated by dotted line 1B-1B in FIG. 1A.

FIG. 2A is a schematic plan view of a cartridge.

FIG. 2B is a schematic view of an end surface of the cartridge cut at the position indicated by dotted line 2B-2B in FIG. 2A.

FIG. 3A is a schematic plan view of a cartridge.

FIG. 3B is a schematic view of an end surface of the cartridge cut at the position indicated by dotted line 3B-3B in FIG. 3A.

FIG. 4 is a perspective view of a container constituting a termite control device.

FIG. 5 is a perspective view of a container constituting a termite control device in another embodiment.

FIG. 6 is a schematic diagram showing another embodiment of the termite control method.

FIG. 7A is a photograph of a cartridge used in an example.

FIG. 7B is a photograph of a container used in an example.

### DETAILED DESCRIPTION OF THE INVENTION

The following is a description of embodiments of the present invention with reference to the drawings. Each figure is illustrated schematically with respect to shape, size, and arrangement of components so that the present invention can be understood. The present invention is not limited by the following embodiments, and each component can be changed when appropriate without departing from the scope and spirit of the invention. In each figure used in the following explanation, similar components are denoted by the same reference numbers and duplicate descriptions may be omitted.

### [Cartridges]

### (1) Common Configuration

The common configuration of all cartridges will now be described. A cartridge is a structure that contain members composed of a material that is resistant to decay or corrosion in soil and resistant to feeding damage, thereby reducing feeding damage by termites (the “material” below), and that has as passage through which termites can move. The structure is resistant to feeding damage and reduces loss due to termites because it includes members composed of a feeding resistant material that reduces feeding damage caused by termites. The structure also contains an unavoidable and slow-acting insecticide active ingredient. Therefore, termites moving through the cartridge are exposed to the insecticide active ingredient for a certain period of time but are not immediately killed, and the interior of the cartridge does not become quickly filled with dead termites. Because the structure contains an insecticide active ingredient, termite paths are less likely to be formed in a termite passage inside the cartridges, and preferably no termite paths are formed at all. As a result, the cartridge does not need to be replaced frequently and can be used until the expiration date of the insecticide active ingredient.

Specifically, the material can be a resin material, a metal material, a ceramic material, or a composite of these materials. Here, the resin material can be, for example, an acrylonitrile-butadiene-styrene resin, a polylactic acid resin, an acrylate-styrene-acrylonitrile resin, a polypropylene resin, a polyethylene terephthalate resin, an epoxy resin, an acrylic resin, a polycarbonate resin, a nylon resin, a thermoplastic polyurethane resin, a polymethyl methacrylate resin, a polyvinylidene fluoride resin, or a polyethylene resin. Examples of metal materials include stainless steel materials, aluminum materials, and titanium materials. Examples of ceramic materials include barium titanate materials, lead zirconate titanate materials, silicon carbide materials, and aluminum nitride materials.

Specific examples of insecticide active ingredients include phenylpyrazole insecticide active ingredients such as fipronil, ethiprole, and pyriprole; neonicotinoid insecticide active ingredients such as imidacloprid, thiacloprid, thiamethoxam, clothianidin, dinotefuran, and acetamiprid; diamide insecticide active ingredients such as flubendiamide, tetraniliprole, chlorantraniliprole, cyclaniliprole, and cyantraniliprole; metadiamide insecticide active ingredients such as broflanilide; phenylurea insecticide active ingredients such as novaluron, teflubenzuron, bistrifluron, diflubenzuron, hexaflumuron, nobiflumuron, chlorfluazuron, and triflumuron; sulfoxyimine insecticide active ingredients such as sulfoxaflor; butenolide insecticide active ingredients such as flupyradifurone; mesoionic insecticide active ingredients such as dichloromezothiaz and triflumezopyrim; pyridylidene insecticide active ingredients such as flupirimine; and isoxazoline insecticide active ingredients such as fluxametamide and isocycloseram.

The amount of insecticide active ingredient should be 1% by weight or less of the cartridge material, but from 0.05% to 0.5% by weight is more preferred. When the amount of insecticide active ingredient is 0.05% by weight or more, termites can be sufficiently exposed to the insecticide active ingredient. Termites that have been sufficiently exposed to the insecticide active ingredient will transmit the agent to other termites by grooming. As a result, a certain percentage of the colony population will die, and the termites, being social insects, will not be able to maintain the colony, thus inhibiting or eradicating termite activity. When the amount of insecticide active ingredient is 1% by weight or less, an excessive amount of insecticide active ingredient is not used and so this is more economical.

The cartridge is not limited to a particular size, as long as it can be accommodated in the container used by the termite control device. For example, the cartridge can be 20 to 30 cm deep by 5 to 30 cm wide by 20 to 30 cm high.

The cartridge can contain a termite-attracting ingredient if needed. Termite-attracting ingredients include, for example, pheromones, sugar-containing aqueous solutions (for example, Pocari Sweat®, and wood materials containing cellulose.

### (2) Embodiment

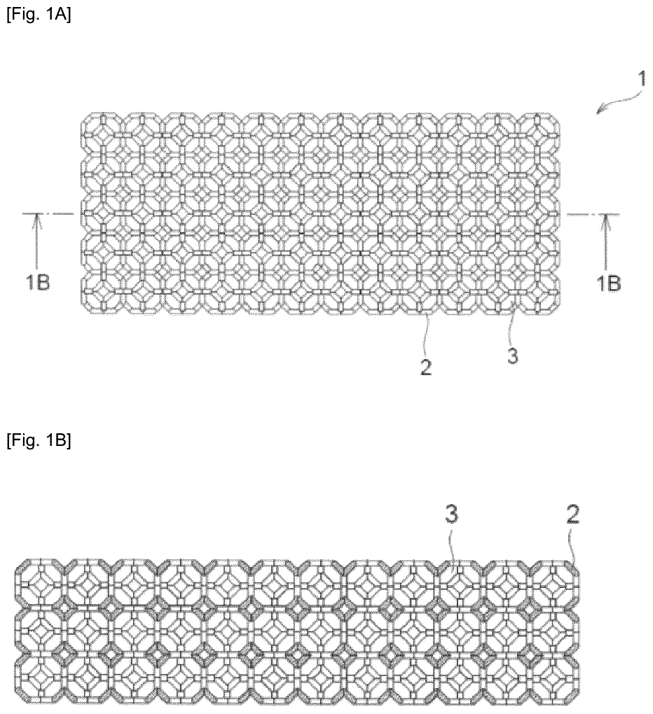

An embodiment of a cartridge will now be described with reference to FIG. 1a and FIG. 1b. In this embodiment, the cartridge 1 has a cell structure with 3 cells that are formed compartmentally by the member 2. In this embodiment, the cells 3 form passages through which termites can travel. In FIG. 1a and FIG. 1b, the member 2 that forms the cells 3 is composed of a combination of octagons and squares. However, the cell structure in cartridges is not limited to this embodiment, and may be composed, for example, simply of squares, or combinations of hexagons and squares, etc.

In this embodiment, the diameter of the cell structures is preferably from 2 to 5 mm, and more preferably from 2 to 3 mm. The diameter of a cell structure is calculated by inscribing an elliptical form around the cells (void), and taking the average of the long axis LH and the short axis WH of the inscribed ellipse.

In this embodiment, the insecticide active ingredient adheres to the surface of the member and/or is kneaded into the member. One method of adhering the insecticide active ingredient to the surface of the member is, for example, to immerse the member in an aqueous solution of the insecticide active ingredient or a solvent in which the insecticide active ingredient has been dissolved. One method of kneading the insecticide active ingredient into the member is, for example, to create cell structures using a melted material composed of a resin material listed above and an insecticide active ingredient.

### (3) Another Embodiment

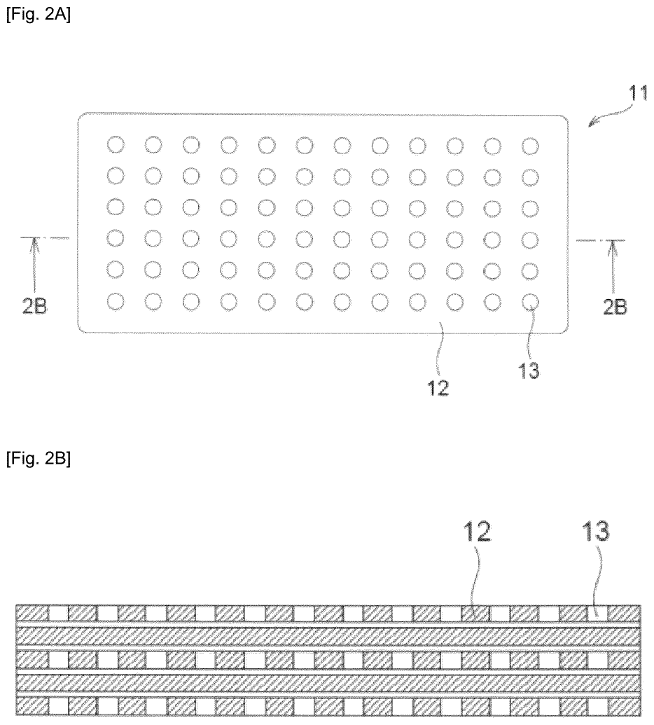

Another embodiment of a cartridge will now be described with reference to FIG. 2a and FIG. 2b. In this embodiment, the cartridge 11 is a panel-shaped structure with a plurality of through-holes 13 in a panel-shaped member 12 made of the material. In this embodiment, the through-holes 13 form passages through which termites can move. In FIG. 2, the through-holes 13 are round, but the through-holes 13 in the cartridge 11 are not limited to this shape and may be oval, rectangular, slit-shaped, etc.

In this embodiment, the through-hole diameter is preferably from 2 to 5 mm, and more preferably from 2 to 3 mm. If the through-holes are round, oval-shaped, rectangular, etc., the hole diameter refers, respectively, to the diameter, long axis diameter, or length of the long side. If the through-holes are slit-shaped, the hole diameter is usually represented by the slit width.

The cartridge 11 may be a single-layer panel-shaped structure or, as shown in FIG. 2b, a multiple-layered panel-shaped structure. When the cartridge 11 is a layered structure, the number of layers, while not limited, may be from two to ten layers. The through-holes may be formed at overlapping positions in the stacking direction of the plurality of plate-shaped members, or they may be formed alternately at non-overlapping positions. FIG. 2b shows a plurality of panel-shaped members with through-holes formed in non-overlapping positions in the stacking direction. In FIG. 2b, a space is shown between the plate-shaped members, but this is a schematic representation of the boundaries between plate-shaped members, which are actually gaps.

In this embodiment, the insecticide active ingredient adheres to the surface of the member and/or is kneaded into the member. One method of adhering the insecticide active ingredient to the surface of the member is, for example, to immerse the member in an aqueous solution of the insecticide active ingredient or a solvent in which the insecticide active ingredient has been dissolved. One method of kneading the insecticide active ingredient into the member is, for example, to create the plate-like structure using a melted material composed of a resin material listed above and an insecticide active ingredient.

### (4) Another Embodiment

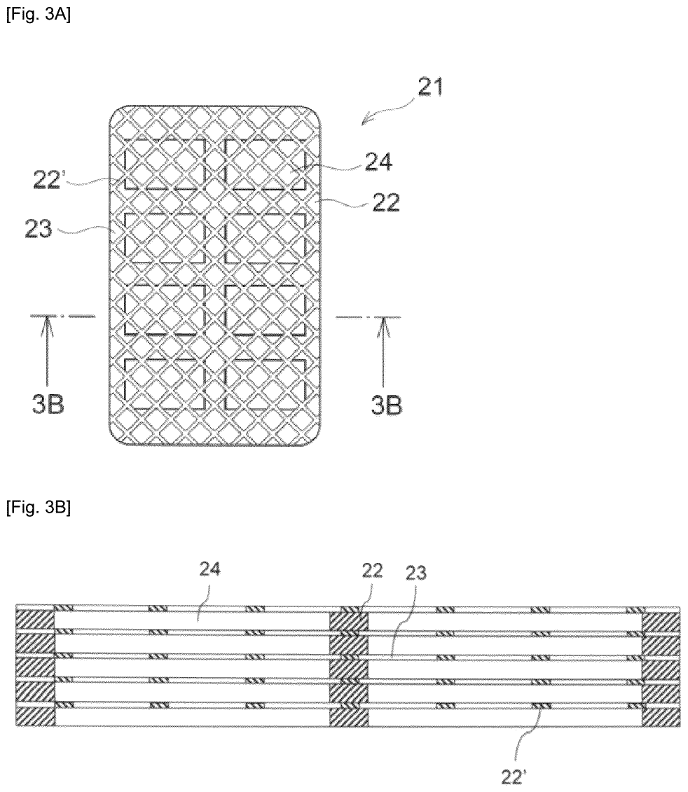

Another embodiment of a cartridge will now be described with reference to FIG. 3a and FIG. 3b. In this embodiment, the cartridge 21 is a mesh-like structure composed of the material and including a support member 22 with openings 24 and a mesh-like member 22′ on the support member 22. In this embodiment, the opening 24 in the support member 22 and the openings 23 in the mesh-like member 22′ form passages through which termites can move. In FIG. 3a, the openings 24 are square, but the openings 24 in the cartridge 21 are not limited to this shape and may be round, oval-shaped, slit-shaped, etc.

In this embodiment, the diameter of the openings in the mesh-like member is preferably from 2 to 5 mm, and more preferably from 2 to 3 mm. The diameter of the openings in the mesh-like member is usually represented by the mesh gap. The diameter of the openings in the support member is not limited, and may be any diameters large enough to allow the mesh-like member to be installed on the support member.

The cartridge 21 may have a single-layer structure or, as shown in FIG. 3b, may have a layered structure consisting of a plurality of mesh-like structures. When the cartridge 21 has a layered structure, the number of layers, while not limited, may be from two to ten.

In this embodiment, the insecticide active ingredient adheres to the surface of the mesh-like member and/or is kneaded into the mesh-like member. Alternatively, the insecticide active ingredient adheres to the surface of the support member and/or is kneaded into the support member. One method of adhering the insecticide active ingredient to the surface of the mesh-like member is, for example, to immerse the mesh-like member in an aqueous solution of the insecticide active ingredient or a solvent in which the insecticide active ingredient has been dissolved. One method of kneading the insecticide active ingredient into the mesh-like member is, for example, to create the mesh-like member using a melted material composed of a resin material listed above and an insecticide active ingredient. The material of the support member and the material of the mesh member may be the same or different, but it is preferably the same.

### (5) Another Embodiment

Another embodiment of a cartridge not shown in any of the drawings will now be described. In this embodiment, the cartridge has a mesh-like structure consisting of a mesh member made of the material. In this embodiment, the openings in the mesh member form passages through which termites can move.

In this embodiment, the diameter of the openings in the mesh member is preferably from 2 to 5 mm, and more preferably from 2 to 3 mm. The diameter of the openings in the mesh member is usually represented by the mesh gap.

The cartridge may be a structure consisting of a single mesh-like structure or a latticework of a plurality of mesh-like structures stacked on top of each other. When the cartridge is a structure of overlapping mesh structures, the number of mesh structures, while not limited, may be from 2 to 10.

One method of adhering the insecticide active ingredient to the surface of the mesh-like member is, for example, to immerse the mesh-like member in an aqueous solution of the insecticide active ingredient or a solvent in which the insecticide active ingredient has been dissolved. One method of kneading the insecticide active ingredient into the mesh-like member is, for example, to create the mesh-like member using a melted material composed of a resin material listed above and an insecticide active ingredient. In this embodiment, the mesh-like structure should be flexible.

### [Termite Control Device]

The termite control device according to the present invention has a cartridge and a container that can accommodate the cartridge, and is made of a resin, a metal, a ceramic, or a composite of these materials. As mentioned above, the cartridges do not need to be replaced frequently and can be used until the expiration date of the insecticide active ingredient. Thus, the device does not have to be checked frequently, which reduces the cost burden associated with providing a service.

The container has a lid that can be opened and closed on its top surface. This makes it easy to replace the cartridge after its expiration date. A side of the container has a plurality of through-holes or slits through which termites can enter. Also, the bottom of the container preferably has an opening. When the bottom of the container has an opening, if water or fine particles of soil enter the container due to rainfall, they readily flow out of the container. Therefore, the termite control device in this embodiment of the present invention is suitable for outdoor use. The opening in the bottom of the container is not limited, and may be a single large opening, a plurality of through-holes, or a slit.

The interior space of the container may be provided with a partition member that forms a partition in the longitudinal direction as long as it can accommodate the cartridge. The partition member prevents damage or deformation of the container when pressure is applied to the container due to rainfall or some other factor. The position and number of partition members can be adjusted depending on the size of the container, but from the perspective of accommodating a cartridge, a single partition in the center in the longitudinal direction is preferred. When a partition member is provided in the interior space of the container, the cartridge is preferably accommodated in all of the space partitioned by the partition member.

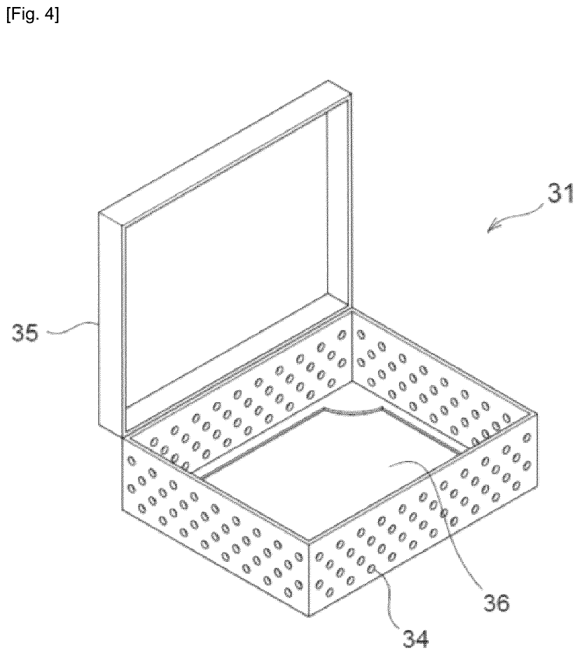

An embodiment of the container 31 will now be described with reference to FIG. 4. In FIG. 4, a lid 35 is connected to the container, but the container and the lid may be separate. The sides of the container have a plurality of round through-holes 34, but the shape of the side through-holes is not limited to this example and may be oval-shaped, rectangular, diamond-shaped, etc. Slits may be formed instead of through holes, and if slits are formed, they should be sloped downward to prevent soil and water from entering. The bottom of the container has a large opening 36, but the shape of the opening in the bottom is not limited to this. For example, a plurality of small through-holes may be provided, similar to the through-holes on the sides, or slits may be provided.

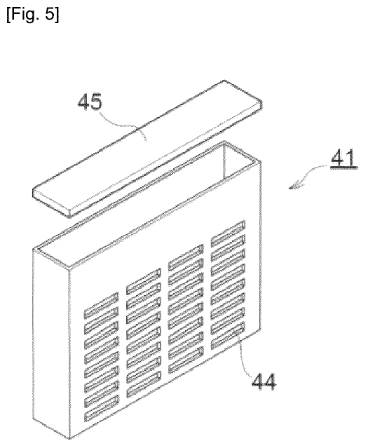

Another embodiment of the container 41 will now be described with reference to FIG. 5. In FIG. 5, the lid 45 is separate from the container, but the container and the lid may be connected. A plurality of slits 44 are formed on the sides of the container parallel to the bottom, but the slits may be sloped downward to prevent soil and water from entering. Through-holes may be formed on the sides instead of slits. The through-holes may be round, oval-shaped, rectangular, diamond-shaped, etc. Although not shown in a drawing, the bottom of the container may have an opening, and there are no particular restrictions on the size of the opening.

Although not shown, the lid should have a child proof mechanism. A child proof mechanism is any mechanism that prevents accidents due to tampering by children, for example, a mechanism that cannot be easily opened or closed without using a key. The key may be a dedicated key or master key, or it may be a card key, electronic key, or biometric authentication such as fingerprint authentication.

The material of the container can be a resin, a metal, a ceramic, or a composite of these materials. More specifically, resins such as polypropylene or polyvinyl chloride resin, a metal such as stainless steel, titanium, or aluminum, or a ceramic such as silicon carbide material or aluminum nitride material can be used.

The size of the container is not limited, as long as it can accommodate the cartridge. One example is 30 to 40 cm deep by 5 to 40 cm wide by 30 to 40 cm high.

### [Termite Control Method]

The termite control method protects a building from termite damage using the termite control device described above, and the method comprises a step of burying the termite control device in soil surrounding the building so that at least some of the through-holes or slits in a side surface of the container through which termites can enter are in the soil. As mentioned above, the termite control device is buried in soil surrounding the building so that at least some of the through-holes or slits in a side surface of the container through which termites can enter are in the soil. Termites enter through a through-hole or slit in the container in the soil through random probing behavior and are exposed to the insecticide active ingredient for a period of time as they move through a passage in the cartridge. Because the insecticide active ingredient is unavoidable and slow-acting, termites that enter the cartridge are exposed to the insecticide active ingredient for a certain period of time but are not immediately killed, and they return to the colony to transmit the insecticide active ingredient to other termites. As a result, a certain percentage of the colony population is killed, and the termites, being social insects, are unable to maintain the colony. In this way, the activity of termites can be inhibited or eradicated.

In the termite control method, the termite control device can be buried in the soil surrounding the building so that at least some the through-holes or slits in the sides of the container through which termites pass are in the soil, or the entire termite control device can be buried in the soil surrounding the building. In a preferred embodiment from the standpoint of replacing the cartridge, the termite control device is buried in the soil surrounding the building so that the lid on the top of the container can be opened and closed. In another preferred embodiment, the entire termite control device is buried at a soil depth where termites are expected to be present. In this embodiment, a removable depth-adjusting member may be provided on the lid on top of the container. The depth-adjusting member may be connected to a guide member described below near the surface of the ground.

The termite control method preferably also includes a step of replacing the cartridge at the expiration date of the insecticide active ingredient. This replacement step allows for low-cost, permanent inhibition or eradication of termite activity.

In the termite control method, a single termite control device may be buried, or multiple termite control devices may be buried. When a single termite control device is buried, it is preferably placed directly at a location with termite damage. A location with termite damage is a location where evidence of termite paths or damage (such as on the surfaces of wooden components, etc.) can be observed. When burying several termite control devices, the termite control devices should preferably be buried at intervals of 0.2 to 6 meters, more preferably at intervals of 0.5 to 5 meters, and even more preferably at intervals of 0.5 to 3 meters.

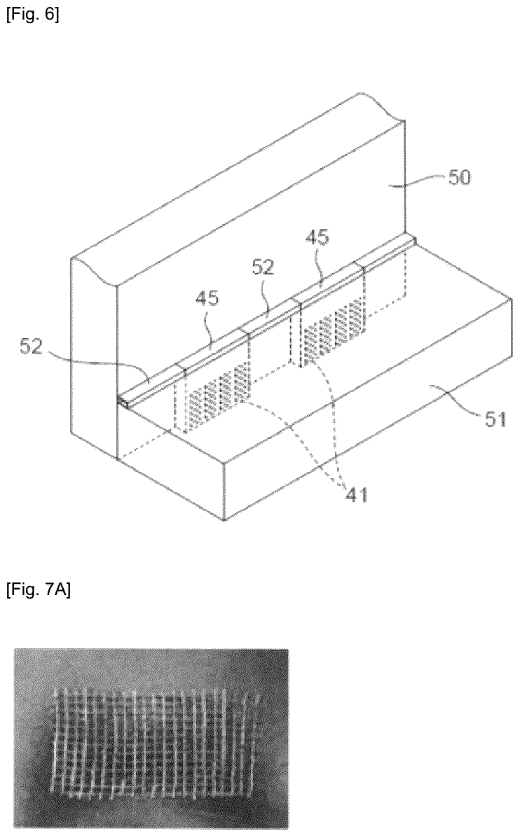

The termite control method preferably involves burying a plurality of termite control devices in the soil surrounding a building and arranging guide members that connect at least some of the plurality of termite control devices to each other. As shown in FIG. 6, a plurality of termite control devices are preferably buried in soil 51 adjacent to the foundation portion 50 of the building, and guide members 52 connecting the termite control devices to each other are preferably placed adjacent to the foundation portion 50. A guide member 52 has a recessed portion along in its longitudinal direction, and the guide member is arranged so that the recessed portion faces downward in the vertical direction. Guide members 52 arranged in this way can take advantage of the habit of termites of moving along objects and around corners, and termites that have risen from the ground between termite control devices can be encouraged to move along the recessed portions of the guide members to a termite control device. In this way, the activity of termites can be further inhibited or eradicated. In FIG. 6, the dotted line indicates portions in soil.

In FIG. 6, a guide member 52 connects the two termite control devices at the ground level. Although not shown in the figure, the guide member connecting the two termite control devices can also be buried in the soil. When guide members are buried in the soil, they are preferably placed closer to the ground surface than to the holes or slits in the side surfaces of the termite control devices from the standpoint of guiding termites that move between termite control devices through a guide member toward a termite control device.

Aspects of the present invention are provided in [1] to [28] below.

[1] A cartridge having a structure including a member composed of a material that is resistant to decay or corrosion in soil and that is resistant to feeding damage by termites, thereby reducing feeding damage by termites, the structure having a passage through which the termites can move, and the structure containing an unavoidable, slow-acting insecticide active ingredient.

[2] The cartridge according to [1], wherein the structure is a cell structure with cells that are partitioned and formed by the member.

[3] The cartridge according to [1], wherein the structure is a panel-shaped structure with a plurality of through-holes in a panel member made of the material.

[4] The cartridge according to any of [1] to [3], wherein the insecticide active ingredient adheres to a surface of the member and/or is kneaded into the member.

[5] The cartridge according to [1], wherein the structure is a mesh-like structure consisting of a mesh member made of the material.

[6] The cartridge according to [1], wherein the structure is a mesh-like structure composed of the material and including a support member having an opening and a mesh member provided on the support member.

[7] The cartridge according to [5] or [6], wherein the insecticide active ingredient adheres to the surface of the mesh member and/or is kneaded into the mesh member.

[8] The cartridge according to any of [1] to [7], wherein the insecticide active ingredient is at least one type selected from the group consisting of a phenylpyrazole insecticide active ingredient, a neonicotinoid insecticide active ingredient, a diamide insecticide active ingredient, a metadiamide insecticide active ingredient, a phenylurea insecticide active ingredient, a sulfoxyimine insecticide active ingredient, a butenolide insecticide active ingredient, a meso-ionic insecticide active ingredient, a pyridylidene insecticide active ingredient, and an isoxazoline insecticide active ingredient.

[9] The cartridge according to [8], wherein the phenylpyrazole insecticide active ingredient is at least one type selected from the group consisting of fipronil, ethiprole, and pyriprole.

[10] The cartridge according to [8], wherein the neonicotinoid insecticide active ingredient is at least one type selected from the group consisting of imidacloprid, thiacloprid, thiamethoxam, clothianidin, dinotefuran, and acetamiprid.

[11] The cartridge according to [8], wherein the diamide insecticide active ingredient is at least one type selected from the group consisting of flubendiamide, tetraniliprole, chlorantraniliprole, cyclaniliprole, and cyantraniliprole.

[12] The cartridge according to [8], wherein the metadiamide insecticide active ingredient is broflanilide.

[13] The cartridge according to [8], wherein the phenylurea insecticide active ingredient is at least one type selected from the group consisting of novaluron, teflubenzuron, bistrifluron, diflubenzuron, hexaflumuron, noviflumuron, chlorfluazuron, and triflumuron.

[14] The cartridge according to [8], wherein the sulfoxyimine insecticide active ingredient is sulfoxaflor.

[15] The cartridge according to [8], wherein the butenolide insecticide active ingredient is flupyradifurone.

[16] The cartridge according to [8], wherein the mesoionic insecticide active ingredient is at least one of dichloromezothiaz and triflumezopyrim.

[17] The cartridge according to [8], wherein the pyridylidene insecticide active ingredient is flupyrimin.

[18] The cartridge according to [8], wherein the isoxazoline insecticide active ingredient is at least one of fluxamethamide and isocycloseram.

[19] The cartridge according to any of [1] to [18], wherein the material is composed of a resin material, a metal material, a ceramic material, or a composite of these materials.

[20] The cartridge according to [19], wherein the resin material is an acrylonitrile-butadiene-styrene resin, a polylactic acid resin, an acrylate-styrene-acrylonitrile resin, a polypropylene resin, a polyethylene terephthalate resin, an epoxy resin, an acrylic resin, a polycarbonate resin, a nylon resin, a thermoplastic polyurethane resin, a polymethyl methacrylate resin, a polyvinylidene fluoride resin, or a polyethylene resin.

[21] A termite control device comprising: the cartridge according to any of [1] to [20]; and a container that is able to accommodate the cartridge and that is composed of a resin, a metal, a ceramic, or a composite of these materials, wherein the container has a lid that can be opened and closed on the top surface thereof, and that has a plurality of through-holes or slits in a side surface thereof through which termites can enter.

[22] The termite control device according to [21], wherein the bottom surface thereof has an opening.

[23] The termite control device according to [21] or [22], wherein the lid has a child proof mechanism.

[24] A termite control method for protecting a building from termite damage using the termite control device according to [21] to [23], the method comprising a step of burying the termite control device in soil surrounding the building so that at least some of the through-holes or slits in a side surface of the container through which termites can enter are in the soil.

[25] The termite control method according to [24], further comprising a step of replacing the cartridge according to any of [1] to [20] at the expiration date of the insecticide active ingredient.

[26] The termite control method according to [24] or [25], further comprising a step of burying a plurality of the termite control devices in soil surrounding the building and arranging guide members to connect at least some of the plurality of the termite control devices.

[27] The termite control method according to [26], wherein a plurality of the termite control devices and the guide members are arranged adjacent to the foundation portion of the building.

[28] The termite control method according to [26], wherein the guide member has a recessed portion arranged in the longitudinal direction thereof, and the guide member is arranged so that the recessed portion faces downward in the vertical direction.

### EXAMPLES

The present invention will be described in greater detail using examples, but the present invention is not limited to these examples. Unless otherwise stated, all percentages used in the present invention are mass based. Also, unless otherwise stated, all units and measurement methods used herein are in accordance with Japanese Industrial Standards (JIS).

The materials and species of termite used in the examples and comparative example are listed below.

Termites: Coptotermes formosanus

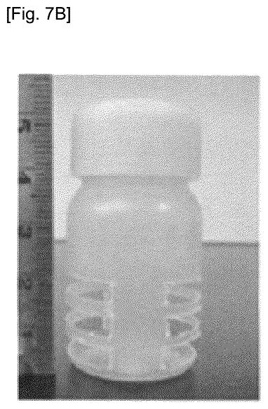

Cartridge: 4-mm polyethylene mesh treated with 0.2 g of Agenda® MC (0.7% by mass fipronil equivalent) (FIG. 7A)

Container: 52-mm high, 31-mm diameter plastic bottle with a 40 mm long×3 mm wide slit in the side (FIG. 7B)

Case: 270 mm (L)×360 mm (W)×180 mm (H)

Bricks: 60 mm (L)×210 mm (W)×100 mm (H)

Piece of Wood: 20 mm (L)×20 mm (W)×40 mm (H).

Soil: Soil with 25% moisture content

### [Termite Activity Index]

The termites were rated on a 10-point relative scale on the basis of the subjectivity of the same experimenter, with 10 points being the point at which termites were introduced to the test device and 0 points being the point at which no termites exhibiting activity were present.

### Example 1

Termite control devices were prepared by placing a cartridge in a container. Two bricks were placed in the center of a case filled with soil to a height of 25 mm, and a piece of wood was placed on the top of the bricks. Six of the prepared termite control devices were placed around the base of the bricks. The termite control device was buried so that the slit was in the soil. The case was then filled with 2,200 termites. All termites were dead after 15 days. No formation of termite paths was observed. The wood weight loss was 3% by mass. Table 1 lists the termite activity indices and the presence or absence of termite path formation.

### Example 2

After Example 1, 2,200 termites were re-introduced without any change to the termite control devices. All termites were dead after 11 days. No formation of termite paths was observed. The wood weight loss was 1% by mass. Table 1 lists the termite activity indices and the presence or absence of termite path formation.

### Comparative Example

Termites were observed under the same conditions as in Example 1, except that the termite control devices were not installed. All termites were still active after 15 days. Formation of termite paths was also observed after 11 days. The wood weight loss was 12% by mass. Table 1 lists the termite activity indices and the presence or absence of termite path formation.

TABLE 1

| | Ex. 1 | | Ex. 2 | | C. Ex. | |
|---|---|---|---|---|---|---|
| | Activity | Path | Activity | Path | Activity | Path |
| | Index | Formation | Index | Formation | Index | Formation |
| After | 10 | No | 10 | No | 10 | No |
| Day 1 | | | | | | |
| After | 10 | No | 9 | No | 10 | No |
| Day 2 | | | | | | |
| After | 8 | No | 8 | No | 10 | No |
| Day 3 | | | | | | |
| After | 5 | No | 6 | No | 10 | No |
| Day 4 | | | | | | |
| After | 5 | No | 4 | No | 10 | No |
| Day 5 | | | | | | |
| After | 4 | No | 3 | No | 10 | No |
| Day 6 | | | | | | |
| After | 4 | No | 2 | No | 10 | No |
| Day 7 | | | | | | |
| After | 4 | No | 1 | No | 10 | No |
| Day 8 | | | | | | |
| After | 3 | No | 1 | No | 10 | No |
| Day 9 | | | | | | |
| After | 3 | No | 1 | No | 10 | No |
| Day 10 | | | | | | |
| After | 2 | No | 0 | No | 10 | Yes |
| Day 11 | | | | | | |
| After | 2 | No | — | No | 10 | Yes |
| Day 12 | | | | | | |
| After | 1 | No | — | No | 10 | Yes |
| Day 13 | | | | | | |
| After | 1 | No | — | No | 10 | Yes |
| Day 14 | | | | | | |
| After | 1 | No | — | No | 10 | Yes |
| Day 15 | | | | | | |
| After | 0 | No | — | No | 10 | Yes |
| Day 16 | | | | | | |

It is clear from Table 1 that when a termite control device containing a cartridge according to the present invention is used, the formation of termite paths is not observed and the device can be used over and over again. The results from Example 2 in particular show that infestations and activity by termites can be inhibited or eradicated, even when the cartridge has not been replaced after a certain amount of time. Therefore, the cartridge does not need to be replaced frequently and can be used until the expiration date of the insecticide active ingredient. Thus, the device does not have to be checked frequently, which reduces the cost burden associated with providing a service. The termite control method can also inhibit or eradicate the activity of termites, as all termites were killed when the termite control device was used.

### KEY TO THE DRAWINGS

1, 11, 21: Cartridge
2: Member
12: Panel member
22: Support member
22′: Mesh member
3: Cell
13: Through-hole
23, 24: Opening
31, 41: Container
34: Through-hole
35, 45: Lid
36: Opening
44: Slit
50: Foundation portion
51: Soil
52: Guide member

1. A cartridge having a structure including a member composed of a material that is resistant to decay or corrosion in soil and that is resistant to feeding damage by termites, thereby reducing feeding damage by termites,
the structure having a passage through which the termites can move, and
the structure containing an unavoidable, slow-acting insecticide active ingredient.

2. The cartridge according to claim 1, wherein the structure is a cell structure with cells that are partitioned and formed by the member.

3. The cartridge according to claim 1, wherein the structure is a panel-shaped structure with a plurality of through-holes in a panel member made of the material.

4. The cartridge according to claim 2 or 3, wherein the insecticide active ingredient adheres to a surface of the member and/or is kneaded into the member.

5. The cartridge according to claim 1, wherein the structure is a mesh-like structure consisting of a mesh member made of the material.

6. The cartridge according to claim 1, wherein the structure is a mesh-like structure composed of the material and including a support member having an opening and a mesh member provided on the support member.

7. The cartridge according to claim 5 or 6, wherein the insecticide active ingredient adheres to the surface of the mesh member and/or is kneaded into the mesh member.

8. The cartridge according to claim 1, wherein the insecticide active ingredient is at least one type selected from the group consisting of a phenylpyrazole insecticide active ingredient, a neonicotinoid insecticide active ingredient, a diamide insecticide active ingredient, a metadiamide insecticide active ingredient, a phenylurea insecticide active ingredient, a sulfoxyimine insecticide active ingredient, a butenolide insecticide active ingredient, a meso-ionic insecticide active ingredient, a pyridylidene insecticide active ingredient, and an isoxazoline insecticide active ingredient.

9. The cartridge according to claim 8, wherein the phenylpyrazole insecticide active ingredient is at least one type selected from the group consisting of fipronil, ethiprole, and pyriprole.

10. The cartridge according to claim 8, wherein the neonicotinoid insecticide active ingredient is at least one type selected from the group consisting of imidacloprid, thiacloprid, thiamethoxam, clothianidin, dinotefuran, and acetamiprid.

11. The cartridge according to claim 8, wherein the diamide insecticide active ingredient is at least one type selected from the group consisting of flubendiamide, tetraniliprole, chlorantraniliprole, cyclaniliprole, and cyantraniliprole.

12. The cartridge according to claim 8, wherein the metadiamide insecticide active ingredient is broflanilide.

13. The cartridge according to claim 8, wherein the phenylurea insecticide active ingredient is at least one type selected from the group consisting of novaluron, teflubenzuron, bistrifluron, diflubenzuron, hexaflumuron, noviflumuron, chlorfluazuron, and triflumuron.

14. The cartridge according to claim 8, wherein the sulfoxyimine insecticide active ingredient is sulfoxaflor.

15. The cartridge according to claim 8, wherein the butenolide insecticide active ingredient is flupyradifurone.

16. The cartridge according to claim 8, wherein the mesoionic insecticide active ingredient is at least one of dichloromezothiaz and triflumezopyrim.

17. The cartridge according to claim 8, wherein the pyridylidene insecticide active ingredient is flupyrimin.

18. The cartridge according to claim 8, wherein the isoxazoline insecticide active ingredient is at least one of fluxamethamide and isocycloseram.

19. The cartridge according to claim 1, wherein the material is composed of a resin material, a metal material, a ceramic material, or a composite of these materials.

20. The cartridge according to claim 19, wherein the resin material is an acrylonitrile-butadiene-styrene resin, a polylactic acid resin, an acrylate-styrene-acrylonitrile resin, a polypropylene resin, a polyethylene terephthalate resin, an epoxy resin, an acrylic resin, a polycarbonate resin, a nylon resin, a thermoplastic polyurethane resin, a polymethyl methacrylate resin, a polyvinylidene fluoride resin, or a polyethylene resin.

21. A termite control device comprising:
the cartridge according to claim 1; and
a container that is able to accommodate the cartridge and that is composed of a resin, a metal, a ceramic, or a composite of these materials,
wherein the container has a lid that can be opened and closed on the top surface thereof, and has a plurality of through-holes or slits in a side surface thereof through which termites can enter.

22. The termite control device according to claim 21, wherein the bottom surface thereof has an opening.

23. The termite control device according to claim 21 or 22, wherein the lid has a child proof mechanism.

24. A termite control method for protecting a building from termite damage using the termite control device according to claim 21, the method comprising a step of burying the termite control device in soil surrounding the building so that at least some of the through-holes or slits in a side surface of the container through which termites can enter are in the soil.

25. The termite control method according to claim 24, further comprising a step of replacing the cartridge according to claim 1 at the expiration date of the insecticide active ingredient.

26. The termite control method according to claim 24 or 25, further comprising a step of burying a plurality of the termite control devices in soil surrounding the building and arranging guide members to connect at least some of the plurality of the termite control devices.

27. The termite control method according to claim 26, wherein a plurality of the termite control devices and the guide members are arranged adjacent to the foundation portion of the building.

28. The termite control method according to claim 26, wherein the guide member has a recessed portion arranged in the longitudinal direction thereof, and
the guide member is arranged so that the recessed portion faces downward in the vertical direction.
